(19) United States
(12) Patent Application Publication
(10) Pub. No.: US 2009/0285156 A1
(43) Pub. Date: Nov. 19, 2009

(54) METHOD, APPARATUS AND SYSTEM FOR SCHEDULING SDMA CODEBOOKS

(75) Inventors: Yongming HUANG, Shenzhen (CN); Luxi YANG, Shenzhen (CN); Hufei ZHU, Shenzhen (CN); Yinggang Du, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/429,725

(22) Filed: Apr. 24, 2009

Related U.S. Application Data
(63) Continuation of application No. PCT/CN2007/070911, filed on Oct. 17, 2007.

(30) Foreign Application Priority Data
Oct. 26, 2006 (CN) 200610137277.4
Nov. 2, 2006 (CN) 200610063504.3

(51) Int. Cl. H04W 4/00; H04L 12/28

(52) U.S. Cl. 370/328; 370/431

(57) ABSTRACT

A method for scheduling an SDMA codebook includes: selecting, by a user, a most matching precoding matrix and a minimally interfering cluster in the SDMA codebook according to Channel State Information, CSI, of the user; calculating a data transmission rate supportable when the user undergoes interference caused by the minimally interfering cluster; and feeding back an index of the most matching precoding matrix, an index of the minimally interfering cluster, and the data transmission rate to a base station. An apparatus and system for scheduling an SDMA codebook is also provided.

### CROSS REFERENCE TO RELATED APPLICATIONS

This application claims priority to Chinese Patent Application No. 200610137277.4, filed with the Chinese Patent Office on Oct. 26, 2006 and entitled “Method for Constructing and Scheduling SDMA Codebooks”, and Chinese Patent Application No. 200610063504.3, filed with the Chinese Patent Office on Nov. 2, 2006 and entitled “Method for Constructing and Scheduling SDMA Codebooks”, which are hereby incorporated by reference in their entirety.

### FIELD OF THE INVENTION

The present invention relates to mobile communication, and in particular, a method, apparatus and system for scheduling SDMA codebooks.

### BACKGROUND

The voice service, data service and broadband Internet service that are increasing in the mobile communication in the future impose higher requirements on the communication system with respect to transmission rate, performance and system service capacity. In order to meet such requirements, it is necessary to not only utilize more spectrum resources, but also introduce radio signal space resources, namely, use multiple antennas to send and receive signals.

The SDMA technology makes the most of the space resources of the multi-antenna system, thus multiplying the spectrum utilization ratio of the existing system. The linchpin of SDMA is to control the interference between multiplexing users. In theory, the base station needs to exactly know the Channel State Information (CSI) of the multiplexing users before being able to sufficiently control or fully eliminate the interference between users through the technologies such as precoding. In an actual radio communication system, especially a system based on the Frequency Division Duplex (FDD) mode, it is almost impossible for a base station to exactly know the user CSI. The CSI is generally not applied even if the user feeds back the CSI because the overhead of the CSI is too high and many user precoding schemes available in the prior art are rather sensitive to the feedback error of the CSI.

Meanwhile, fast scheduling has become one of the key technologies of the B3G/4G (beyond 3G/4G). In a multi-user environment, Opportunistic Scheduling (OS) can use multi-user diversity to improve the average throughput of the system. In an SDMA mode based on the codebook mode, the feedback information of the user is limited by the feedback amount first. Meanwhile, the user knows only the local information and is unable to know the information about other users. That is, the users in a mobile communication system in the prior art are not interoperable, and the information available from the user to the base station is limited. Linchpins of the OS SDMA technology are: how a base station uses the collected feedback data in a limited amount and with limited information to schedule the multiplexing users quickly and send data at the same frequency; and how to make full use of the multi-user diversity and space resources. Moreover, the quality of codebook design directly affects the system performance and the amount of the data to be fed back, and is the second key technology of the OS SDMA scheme.

Different from the precoding matrix codebook design of a single user, the SDMA codebook needs to preliminarily consider how to control the interference between users. The codebooks of the SDMA scheme provided in the IEEE802.20 are based on the clustering (two clusters) conception. The conception may be understood as: The transmitting space is divided into two sub-spaces, and each sub-space corresponds to a scheduled user. In fact, the granularity of space division is critical to improving the system performance. However, over-refined space division increases feedback overhead and difficulty of designing the scheduling algorithm.

As described above, in the prior art, over-refined space division increases feedback overhead and difficulty of designing the SDMA scheduling algorithm.

### SUMMARY

Various embodiments of the present invention provides a method and apparatus for scheduling SDMA codebooks to reduce user feedback information bits and simplify the SDMA scheduling.

A method for scheduling an SDMA codebook is disclosed herein. The method includes:

selecting, by a user, the most matching precoding matrix and the minimally interfering cluster in the SDMA codebook according to the CSI of the user;

calculating the data transmission rate supportable when the user undergoes interference caused by the minimally interfering cluster; and

feeding back the index of the most matching precoding matrix, the index of the minimally interfering cluster, and the data transmission rate to a base station.

An apparatus for scheduling SDMA includes:

a precoding matrix selecting unit, adapted to select the most matching precoding matrix and the minimally interfering cluster in the SDMA codebook according to the CSI of the user;

a calculating unit, adapted to calculate the data transmission rate supportable when the user undergoes interference caused by the minimally interfering cluster; and

a feedback unit, adapted to feed back the index of the most matching precoding matrix, the index of the minimally interfering cluster, and the data transmission rate to a base station.

A system for scheduling SDMA includes: a base station and a terminal.

The terminal includes:

a precoding matrix selecting unit, adapted to select a most matching precoding matrix and a minimally interfering cluster in an SDMA codebook according to Channel State Information, CSI, of a user;

a calculating unit, adapted to calculate a data transmission rate supportable when the user undergoes interference caused by the minimally interfering cluster; and

a feedback unit, adapted to feed back an index of the most matching precoding matrix, an index of the minimally interfering cluster, and the data transmission rate to a base station;

The base station includes:

a user classifying unit, adapted to: sort users into multiple classes according to a cluster corresponding to the index of the most matching precoding matrix and according to the index of the minimally interfering cluster, the index being received by a base station;

a specific user selecting unit, adapted to select specific users in each class respectively;

a matching and calculating unit, adapted to: match the selected specific users; generate one or more matching pairs, each including two users; and calculate the sum of data transmission rates fed back by the two users in the matching pair; and

a scheduled user selecting unit, adapted to: compare the sum of the data transmission rates between all the matching pairs, select a specific matching pair, and use the two users in the specific matching pair as currently scheduled transmitting users.

Through the foregoing technical solution, the feedback information bits of the users are reduced, the mobile station feedback information unit is simplified, the interference between SDMA users is suppressed drastically, the spectrum utilization ratio is improved, and the system throughput is increased.

### BRIEF DESCRIPTION OF THE DRAWINGS

The accompanying drawings are intended for better understanding of the present invention and constitute part of this application. The exemplary embodiments of the present invention and description thereof are intended for interpreting the present invention rather than limiting the present invention improperly.

FIG. 1 is a flowchart of a method for constructing an SDMA codebook according to the first embodiment of the present invention;

FIG. 2-1 is a schematic diagram of an SDMA scheduling system in an embodiment of the present invention;

FIG. 2-2 is a flowchart of a method for scheduling an SDMA codebook according to the third embodiment of the present invention;

FIG. 3 is a flowchart of a method for scheduling an SDMA codebook according to the fourth embodiment of the present invention;

FIG. 4 is a flowchart of a method for scheduling an SDMA codebook according to the fifth embodiment of the present invention;

FIG. 5-A shows a total throughput in the technical solution of the present invention versus the prior art;

FIG. 5-B shows a total throughput in the technical solution of the present invention versus the prior art;

FIG. 5-C shows a total throughput in the technical solution of the present invention versus the prior art;

FIG. 5-D shows a total throughput in the technical solution of the present invention versus the prior art;

FIG. 5-E shows a total throughput in the technical solution of the present invention versus the prior art; and

FIG. 5-F shows a total throughput in the technical solution of the present invention versus the prior art.

### DETAILED DESCRIPTION

In the embodiments of the present invention, a group of precoding matrixes or beams are pre-designed at the base station and transmitter. The user selects a proper precoding matrix or beam in the codebook according to the channel information of the user, and reports the relevant information to the base station through a low-speed feedback channel by means of a few scalars, thus reducing the system feedback overhead drastically. The base station needs to perform overall scheduling after collecting the feedback information of all requesting users. Besides, the embodiments of the present invention accomplish a perfect tradeoff between the granularity of space division and the complexity of the scheduling algorithm in the process of designing the codebook.

The present invention is elaborated below by reference to embodiments and accompanying drawings.

### Embodiment 1

First, a method for constructing an SDMA codebook is provided in an embodiment of the present invention. The apparatuses available to implement the method include: a channel estimating unit and a feedback information unit at the mobile station, and a scheduling unit and an SDMA transmitting unit at the base station.

In the current upgraded version of the 3GPP/3GPP2, four transmitting antennas are generally deployed at the base station, and 1-2 antennas are generally configured at the mobile station. From the perspective of information theory, if two antennas are configured for each user, the base station can send data to at most two users simultaneously at the same time-frequency resource, and send two data flows to each user. In this case, the size of the precoding matrix of a single user is 4*2. If a singe antenna is configured at the user, the base station can send data to at most four users simultaneously, and send one data flow to each user. In this case, the data flows are sent to a single user through single beams. In view of the foregoing two scenarios, an SDMA codebook is composed of two parts (part 1, part 2). The elements in part 1 are column vectors (beams), which are primarily applied to single-antenna users. The elements in part 2 are 4*2 precoding matrixes, which are primarily applied to dual-antenna users.

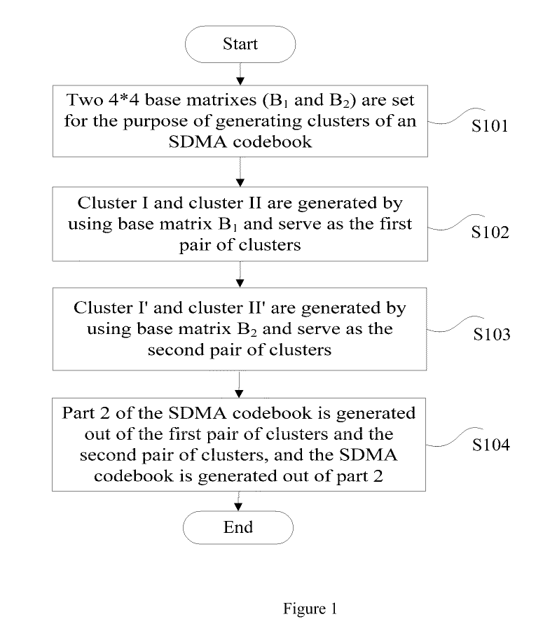

The method for constructing an SDMA codebook in an embodiment of the present invention is described below. As shown in FIG. 1, the method includes the following steps:

Step S101: Two 4*4 base matrixes (B1 and B2) are set for the purpose of generating clusters of an SDMA codebook.

Step S102: Column 1 and column 2 of the base matrix B1, namely, B1 (:, 1:2), are used as generative cluster I of the generative base. Column 3 and column 4 of the base matrix B1, namely, B1 (:, 3:4), are used as generative cluster II of the generative base. Cluster I and cluster II are used as the first pair of clusters.

Step S103: Column 1 and column 2 of the base matrix B2, namely, B2 (:, 1:2), are used as generative cluster I′ of the generative base. Column 3 and column 4 of the base matrix B2, namely, B2 (:, 3:4), are used as generative cluster II′ of the generative base. Cluster I′ and cluster II′ are used as the second pair of clusters.

In the foregoing process, the two columns used as the generative base may be any two columns in the base matrix, which is not limited to the foregoing scenario; moreover, the two columns used as the generative base may come from different base matrixes, for example, the two columns B1 (: 1) and B₂ (: 2). In this case, the four generative bases are: B1 (: 1) and B₂ (: 2), B1 (: 2) and B₂ (: 3), B1 (: 3) and B₂ (: 4), and B1 (: 4) and B₂ (: 1).

In the foregoing step S104, it is defined that Uᵢ=ΔᵢD, where

$${Δ}_{i} = [ \begin{matrix}{e}^{j {φ}_{i 1}} & \\ & {e}^{j {φ}_{i 2}}\end{matrix} ] ,$$

φᵢ₁, φᵢ₂ are random variables distributed uniformly between 0 and 2π, and D is a 2*2 discrete Fourier transformation matrix. It is worthy of attention that the value of Δᵢ is a fixed value pre-agreed between the transmitter and receiver.

Specifically, the generative base is multiplied by the corresponding matrix Ui to obtain element i in the cluster. For example, in the case that the generative base is B1 (:, 1:2), element i in cluster i is B1 (:, 1:2)Ui, where B1 (:, 1:2) represents column 1 and column 2 of matrix B1. Similarly, element i in cluster II is B1 (:, 3:4)Ui, where B1 (:, 3:4) represents column 3 and column 4 of matrix B1.

Moreover, if the values of i in the cluster are 1 and 2, it indicates that the cluster includes two elements. If the values of i in the cluster are 1, 2, 3, 4, 5 and 6, it indicates that the cluster includes six elements; and so on.

Step S104: Part 2 of the SDMA codebook is generated out of the first pair of clusters (cluster I and cluster II) and the second pair of clusters (cluster I′ and cluster II′), and the SDMA codebook is generated out of part 2.

Part 2 includes two groups. The first pair of clusters constitute one group, and the second pair of clusters constitute the other. Moreover, the precoding matrix applied to each different user is selected from a different cluster among cluster I, cluster II, cluster I′, and cluster II′. More specifically, each user uses an element in a cluster. That is, each SDMA user, namely, each of the users who occupy the same time-frequency resources, uses a precoding matrix which necessarily comes from a different cluster.

In order to make the embodiments of the present invention clearer, the SDMA codebook is further described below. An SDMA codebook is composed of part 1 and part 2. Part 1 is composed of set 1 and set 2, and each set includes four elements:

Set 1 is composed of four columns in this unitary matrix:

$${B}_{1} = \frac{1}{2} [ \begin{matrix}1 & 1 & 1 & 1 \\ 1 & {e}^{j π / 2} & {e}^{j π} & {e}^{j 3 π / 2} \\ 1 & {e}^{j π} & {e}^{j2 π} & {e}^{j 3 π} \\ 1 & {e}^{j 3 π / 2} & {e}^{j 3 π} & {e}^{j9 π / 2}\end{matrix} ] ;$$

and

Set 2 is composed of four columns in this unitary matrix:

$${B}_{2} = \frac{1}{2} [ \begin{matrix}1 & 1 & 1 & 1 \\ {e}^{j π / 4} & {e}^{j 3 π / 4} & {e}^{j 5 π / 4} & {e}^{j 7 π / 4} \\ {e}^{j π / 2} & {e}^{j 3 π / 2} & {e}^{j5π / 2} & {e}^{j 7 π / 2} \\ {e}^{j 3 π / 4} & {e}^{j 9 π / 4} & {e}^{j15π / 4} & {e}^{j21π / 4}\end{matrix} ] .$$

Therefore, the length of part 2 in the SDMA codebook generated in step S108 is fourfold as the number of elements in the cluster. For example, supposing that the length of part 1 that constitutes the SDMA codebook is fixed as eight elements, when the cluster includes six elements, the length of part 2 is 24 and the total length of the SDMA codebook is 32; when the cluster includes only two elements, the length of part 2 is 8 and the total length of the SDMA codebook is 16.

This embodiment describes a scenario in which the SDMA codebook is generated out of two 4*4 base matrixes (B₁ and B₂). However, the embodiments of the present invention are not limited to such a scenario. It is understandable that the method under the present invention may be implemented through two or more base matrixes of other structures. That is, part 2 of the codebook in this embodiment includes two groups. The first pair of clusters constitute one group, and the second pair of clusters constitute the other, and there are a total of four clusters. In practice, more than two groups such as three groups or four groups may exist, and each group may include more than two clusters. If there are more groups or clusters, the implementation is more complex but still practicable, without departing from the spirit of the present invention.

Another apparatus for constructing an SDMA codebook includes: a module adapted to set multiple base matrixes; a module adapted to generate multiple clusters through the multiple base matrixes and use the clusters to generate part 2 of the SDMA codebook; and a module adapted to use the part 2 to generate the SDMA codebook. With respect to the detailed process of using this apparatus to construct an SDMA codebook, the description of the method in the first embodiment serves as a reference.

### Embodiment 2

This embodiment provides an SDMA codebook constructed through the SDMA codebook construction method disclosed in the first embodiment. The SDMA codebook is characterized by: Part 2 of the SDMA codebook is composed of two groups, each group is composed of a pair of clusters (there are four clusters in total), and each pair of clusters are generated out of a base matrix.

The SDMA codebook provided in this embodiment is characterized by:

(1) The codebook takes account of single-antenna configuration and dual-antenna configuration of the mobile station.

(2) The codebook is generated randomly to some extent, and may be updated synchronously by the base station and the user at intervals.

(3) Both of the two columns of the matrix element in part 2 of the codebook are orthonormalized, namely, the precoding matrix takes on a semi-unitary feature;

(4) Different elements Wᵢ, Wⱼ, i≠j in the same cluster fulfill WᵢWᵢ^{H}=WⱼWⱼ^{H}. For example, for a channel matrix Hₖ of a given user, the interference caused by a multiplexing user that uses Wᵢ as a precoding matrix onto user k depends on the value of ∥HₖWᵢ∥_{F}²=tr(HₖWᵢWᵢ^{H}Hₖ^{H}). Therefore, the interference caused by all elements in the same cluster onto a given user is the same; and

(5) A random element W_{i,1}, ∀i in cluster I in a pair of clusters and a random element W_{j,2}, ∀j in cluster II fulfill W_{i,1}^{H}W_{j,2}=0. That is, a random element in cluster I and a random element in cluster II fulfill the feature that all columns are mutually orthogonal.

Moreover, the use of the SDMA codebook in this embodiment complies with the following rules:

(1) For the SDMA scheduling of a user configured with two antennas, each cluster is generated out of two columns, and can span into only part of the transmitting space. In order to make the most of space resources, the precoding matrix applied to each multiplexing user need to be selected out of a different cluster. The two columns of each cluster can span into only part of the transmitting space. That is, all countless column vectors deriving from all countless linear combinations of the two columns occupy only part of the space instead of the full space. For example, for the space composed of all column vectors which are 4 in length (namely, including 4 items), the whole space can be span fully only if there are 4 mutually orthogonal base column vectors which are 4 in length. With only two column vectors mentioned above, only part of the space is spanned out.

(2) For SDMA scheduling of a user configured with a single antenna, all columns of a unitary matrix are spanned out as far as possible in a specific direction in order to split the whole transmitting space. The transmitting beams applied to the four users of the SDMA need to be selected out of the same set in part 1 of the codebook.

Therefore, the SDMA codebook provided in this embodiment takes account of the multi-user precoding feature sufficiently, and the composition feature of the SDMA codebook is conducive to reducing the user feedback information bits and simplifying the feedback information unit of the mobile station.

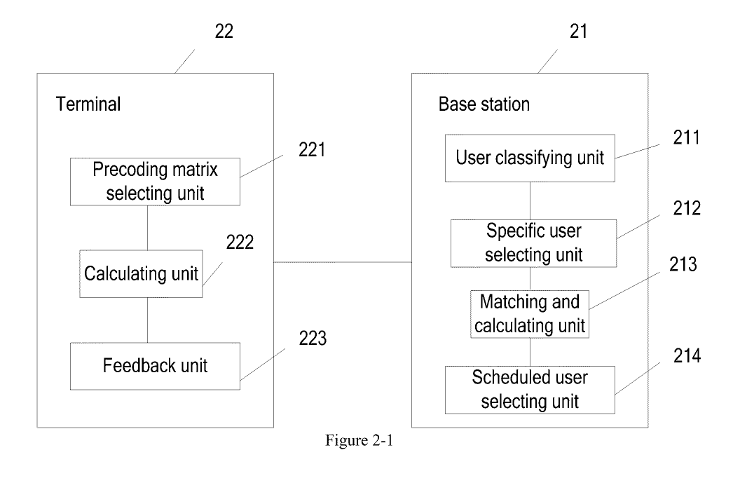

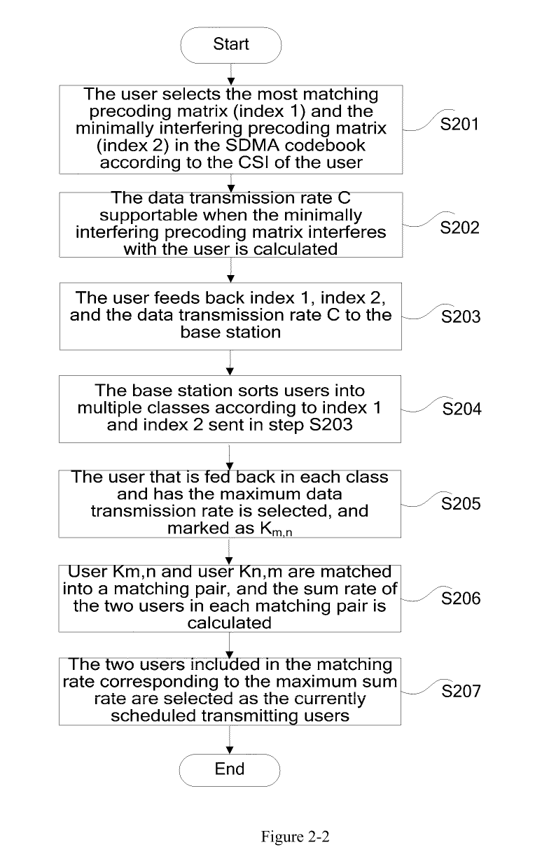

An SDMA scheduling system is provided herein. As shown in FIG. 2-1, the system includes a base station 21 and a terminal 22.

The terminal 22 includes a precoding matrix selecting unit 221, a calculating unit 222, and a feedback unit 223.

The base station 21 includes a user classifying unit 211, a specific user selecting unit 212, a matching and calculating unit 213, and a scheduled user selecting unit 214.

In the terminal 22, the precoding matrix selecting unit 221 is adapted to select the most matching precoding matrix and the minimally interfering cluster in the SDMA codebook according to the CSI of the user. The calculating unit 222 is adapted to calculate the data transmission rate supportable when the user undergoes interference caused by the minimally interfering cluster. The feedback unit 223 is adapted to feed back the index of the most matching precoding matrix, the index of the minimally interfering cluster, and the data transmission rate to a base station.

In the base station 21, the user classifying unit 211 is adapted to: sort users into multiple classes according to the cluster corresponding to the index of the most matching precoding matrix and according to the index of the minimally interfering cluster, where the index is received by the base station. The specific user selecting unit 212 is adapted to select the specific users in each class respectively. The matching and calculating unit 213 is adapted to: match the selected specific users; generate one or more matching pairs, where each matching pair includes two users; and calculate the sum of the data transmission rates fed back by the two users in the matching pair. The scheduled user selecting unit 214 is adapted to: compare the sum of the data transmission rates between all the matching pairs, select a specific matching pair, and use the two users included in the specific matching pair as currently scheduled transmitting users.

The SDMA scheduling is implemented through the terminal and base station in the system provided herein, and the scheduling process is detailed below.

### Embodiment 3

A method for scheduling SDMA codebooks is provided in this embodiment. In the SDMA codebook scheduling method, the SDMA codebook construction method and the SDMA codebook provided in the foregoing embodiments are applicable.

As shown in FIG. 2, the method for scheduling an SDMA codebook in this embodiment includes the following steps:

Step S201: The user selects the most matching precoding matrix (numbered “index 1”) and the minimally interfering cluster (numbered “index 2”, which is a 2-bit datum because the SDMA codebook includes four clusters) in the SDMA codebook according to the CSI of the user, where the most matching precoding matrix includes the most matching cluster and the most matching element in the cluster. It is worthy of attention that for the CSI of a given user, the interference caused by the precoding matrixes of the same cluster onto the CSI is the same. Therefore, the user may search the codebook for the minimally interfering precoding matrix by using a cluster as a unit.

Step S202: The interference of the minimally interfering cluster onto the user is calculated. That is, the parameter for calculating is the data transmission rate C supportable when interference is generated by any precoding matrix in the minimally interfering cluster (in practice, C may be regarded as the maximum capacity supportable by the user after the SDMA scheme is applied).

Step S203: The user feeds back index 1, index 2, and data transmission rate C to the base station.

In the foregoing process, the equivalent baseband receiving signal vector of user k is yₖ=HₖU₁s₁+HₖU₂s₂+nₖ, where U₁ is the transmitting precoding matrix of the user, and is composed of two beams, namely, the user may send two independent data flows at a time. The second algebraic term to the right side of the equal mark in the foregoing formula is regarded as an interfering item to other user data. The codebook convention tells that U₁, U₂ belong to different clusters although both are selected out of part 2 of the codebook. Supposing that the user applies a Minimal Mean Square Error (MMSE) detection method, the receiving signal after linear processing may be expressed as:

$${z}_{k} = {G}_{k}^{H} {y}_{k} = {G}_{k}^{H} {H}_{k} {U}_{1} {s}_{1} + {G}_{k}^{H} {H}_{k} {U}_{2} {s}_{2} + {G}_{k}^{H} {n}_{k} = {G}_{k}^{H} {\breve{H}}_{k , 1} {s}_{1} + {G}_{k}^{H} {\breve{H}}_{k , 2} {s}_{2} + {G}_{k}^{H} {n}_{k} , \\ where$$

$${G}_{k} = {( {H}_{k} {U}_{1} {U}_{1}^{H} {H}_{k}^{H} + {H}_{k} {U}_{2} {U}_{2}^{H} {H}_{k}^{H} + \frac{{N}_{0}}{{E}_{s}} {I}_{N} )}^{- 1} {H}_{k} {U}_{1} .$$

Therefore, for the i type of value of (U₁, U₂) in the codebook, the Signal-to-Interference and Noise Ratio (SINR) of the n data flow (where i and n are ordinal numbers) may be expressed as:

$${μ}_{k , n , i} = \frac{{\vert {( {G}_{k}^{H} {\breve{H}}_{k , 1} )}_{nn} \vert}^{2}}{{\sum }_{m \neq n} {\vert {( {G}_{k}^{H} {\breve{H}}_{k , 1} )}_{nm} \vert}^{2} + {‖ {( {G}_{k}^{H} {\breve{H}}_{k , 2} )}_{n} ‖}^{2} + \frac{{N}_{0}}{{E}_{s}} {‖ {( {G}_{k}^{H} )}_{n} ‖}^{2}} ,$$

where (A)ₙₘ represents (n, m) element of matrix A, (n, m) constitutes an ordinal number, and (A)ₙ represents row n of matrix A.

Therefore, the rate supportable by user k is:

$${C}_{k , i} = {\sum }_{n = 1}^{N} log ( 1 + {μ}_{k , n , i} ) .$$

In order to obtain the maximum rate supportable by user k, it is necessary to traverse all possible scenarios of U₁, U₂ Supposing that the scale of each cluster in part 2 of the codebook is L, U₁, U₂ involves 4 L*3 L possibilities in total because the foregoing rule (1) applies to the codebook. Due to the foregoing characteristic (4) of the codebook, it is not necessary to traverse U₂ in the same cluster any longer after U₁ is selected. Because the precoding matrix in the same cluster imposes the same interference for user k, it is necessary to traverse only 4 L*3 possibilities.

After the foregoing step S203, the scheduling method in this embodiment further includes the following steps:

Step S204: The base station sorts users into 12 classes according to index 2 and the cluster corresponding to index 1 sent in step S203. The value “12” is calculated out in this way: The cluster corresponding to index 1 is m=1, 2, 3, 4, namely, 4 clusters, and index 2=n which is unequal to m, and n=1, 2, 3, 4, thereby the users being sorted into 12 classes.

In this step, if the most matching precoding matrixes fed back by multiple users correspond to the same cluster and the minimally interfering clusters fed back by them are the same, the multiple users are of the same class. The class is represented by (m, n), where m is a serial number of the cluster in an SDMA codebook corresponding to index 1, n is a value of index 2, and m and n are natural numbers not greater than 4.

Step S205: The fed-back user with the maximum data transmission rate in each class is selected. Preferably, the maximum data transmission rate C is marked as C_{m,n}, and the fed-back user with the maximum data transmission rate in each class is marked as Km,n. In this step, if no corresponding fed-back user exists in a class, the class is null, and the C_{m,n} and k_{m,n}, of the class are set to zero.

Step S206: The users marked in step S205 are matched, and therefore, one or more matching pairs are generated, where each pair includes two users. That is, user K_{m,n} is matched with user K_{n, m}, and the sum rate of each pair of matching users is calculated, where sum rate=C_{m,n}+C_{n,m}.

The matching pair generated in this step includes two users, and the cluster corresponding to the most matching precoding matrix fed back by one user is the same as the minimally interfering cluster fed back by the other user. That is, user Km,n is matched with user Kn, m because index 1 and index 2 fed back by the two users correspond to the same two clusters. If the two users in this pair are multiplexed and the matrixes corresponding to index 1 fed back by the two users are selected as transmitting precoding matrixes respectively, the mutual interference between the two users is minimized within the control range of the codebook. Through such a matching mode, a total of six matching pairs are obtained: 1-2 and 2-1, 1-3 and 3-1, 1-4 and 4-1, 2-3 and 3-2, 2-4 and 4-2, and 3-4 and 4-3.

If any of the foregoing six matching pairs lacks two dual-antenna users for scheduling, it is appropriate to schedule one dual-antenna user and two single-antenna users, and the matching pair is known as a hybrid matching pair that combines one dual-antenna user and two single-antenna users. The scheduled two single-antenna users correspond to two most matching columns which are two columns of the generative bases of the minimally interfering cluster of the dual-antenna user scheduled above. For example, the codebook is generated by using two 4*4 base matrixes B₁ and B₂. As described in step S104, the generative bases of part 2 of the codebook are: B1 (:, 1:2), B1 (:, 3:4), B₂(: 1:2), and B₂(:, 3:4) respectively. As mentioned above, part 1 of the codebook is composed of two sets: set 1 and set 2. Each set includes four elements, which are four columns of the corresponding base matrix. That is, the four elements in set 1 are the four columns of the base matrix B1: B1 (: 1), B1 (: 2), B1 (: 3), and B1 (: 4); and the four elements in set 2 are the four columns of the base matrix B2: B2 (: 1), B2 (: 2), B2 (: 3), and B2 (: 4). Therefore, the dual-antenna user and the two single-antenna users who are scheduled may be: For example, the generative base of the minimally interfering cluster of the scheduled dual-antenna user is B2 (:, 3:4), and the two most matching columns corresponding to the two scheduled single-antenna users are B2 (: 3) and B2 (: 4).

If any of the foregoing six matching pairs lacks two dual-antenna users for scheduling and also lacks the foregoing hybrid matching pair (composed of one dual-antenna user and two single-antenna users) for scheduling, it is appropriate to schedule one dual-antenna user and one single-antenna user, and the matching pair is known as a hybrid matching pair composed of one dual-antenna user and one single-antenna user. The scheduled single-antenna user corresponds to a most matching column which is any of the two columns of the generative bases of the minimally interfering cluster of the dual-antenna user scheduled above. For example, the dual-antenna user and the single-antenna user who are scheduled may be: The generative base of the minimally interfering cluster of the scheduled dual-antenna user is B2 (:, 3:4), and the most matching column corresponding to the scheduled single-antenna user is B2 (: 3) or B2 (: 4).

If any of the foregoing six matching pairs lacks two dual-antenna users for scheduling, lacks the foregoing hybrid matching pair (composed of one dual-antenna user and two single-antenna users) for scheduling, and lacks the foregoing hybrid matching pair (composed of one dual-antenna user and one single-antenna user) for scheduling, it indicates that one of the two users in the matching pair corresponds to zero data. In this case, no matching user pair exists, and the data of a single user is sent, without the need of SDMA.

If any of the foregoing six matching pairs lacks users for scheduling, the transmission rate of the matching pair is zero, and the matching pair is not considered for deployment.

Through the foregoing method, one of the following items is obtained: two dual-antenna users that are available for scheduling and correspond to each of the six matching pairs; or, one dual-antenna user and two single-antenna users; or, one dual-antenna user and one single-antenna user; or, one dual-antenna user.

Step S207: The users included in the matching rate corresponding to the maximum sum rate are selected as the currently scheduled transmitting users. As mentioned above, the users may be: users of two dual-antenna users; or one dual-antenna user and two single-antenna users; or one dual-antenna user and one single-antenna user; or one dual-antenna user.

Optionally, in step S205, for fairness to all users, the selected user is the user who fails to obtain services in a long time rather than the fed-back user with the maximum data transmission rate. Preferably, the user who fails to obtain services in a long time is marked as K_{m,n}, and the data transmission rate fed back by the user is marked as C_{m,n}. Accordingly, in step S207, the selected matching pair may be a pair of users, at least one of whom fails to obtain services in a long time; and the two users in the pair serve as the currently scheduled transmitting users. It is evident in the foregoing technical solution that: the feedback bits for the SM-SDMA mode in this embodiment need to include two indexes, of which one index corresponds to the preferred precoding matrix and the other index corresponds to the preferred interfering cluster; when a single-beam SDMA mode is applied, only one index needs to be fed back.

A terminal and base station are also provided in this embodiment. They are similar to the terminal and the base station in the system shown in FIG. 2-1 in this embodiment, and are not detailed here any further.

### Embodiment 4

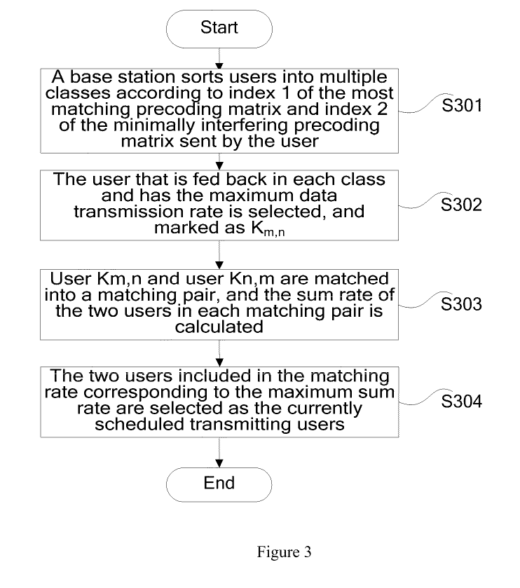

In this embodiment, a method for scheduling SDMA codebooks is provided. The method is primarily applicable to but not limited to dual-antenna users and multi-antenna users. As shown in FIG. 3, the method includes the following steps:

Step S301: The base station sorts the users into multiple classes according to the cluster corresponding to the index (index 1) of the most matching precoding matrix sent by the user and the index (index 2) of the minimally interfering cluster, where the most matching precoding matrixes fed back by multiple users of a class correspond to the same cluster, and the minimally interfering clusters fed back by multiple users of the class are the same.

Step S302: The fed-back user with the maximum data transmission rate in each class is selected. Preferably, the maximum data transmission rate C is marked as C_{m,n}, and the fed-back user with the maximum data transmission rate in each class is marked as K_{m,n}. In this step, if no corresponding fed-back user exists in a class, the class is null, and the C_{m,n} and k_{m,n} of the class are set to zero.

Optionally, in this step, for fairness to all users, the selected user is the user who fails to obtain services in a long time rather than the fed-back user with the maximum data transmission rate. Preferably, the user who fails to obtain services in a long time is marked as K_{m,n}, and the data transmission rate fed back by the user is marked as C_{m,n}.

Step S303: The users marked in step S302 are matched, and therefore one or more matching pairs are generated, where each pair includes two users. That is, user Km,n is matched with user Kn, m, and the sum rate of each pair of matching users is calculated, where sum rate=Cm,n+C n,m.

Among the two users included in the matching pair that is generated in this step, the cluster corresponding to the most matching precoding matrix fed back by one user is the same as the minimally interfering cluster fed back by the other user. That is, user Km,n is matched with user Kn, m because index 1 and index 2 fed back by the two users correspond to the same two clusters. If the two users in this pair are multiplexed and the matrixes corresponding to index 1 fed back by the two users are selected as transmitting precoding matrixes respectively, the mutual interference between the two users is minimized within the control range of the codebook. Through such a matching mode, a total of six matching pairs are obtained: 1-2 and 2-1, 1-3 and 3-1, 1-4 and 4-1, 2-3 and 3-2, 2-4 and 4-2, and 3-4 and 4-3.

As mentioned above, if any of the foregoing six matching pairs lacks two dual-antenna users for scheduling, it is appropriate to schedule one dual-antenna user and two single-antenna users, and the matching pair is known as a hybrid matching pair that combines one dual-antenna user and two single-antenna users. If any of the foregoing six matching pairs lacks two dual-antenna users for scheduling and also lacks the foregoing hybrid matching pair (composed of one dual-antenna user and two single-antenna users) for scheduling, it is appropriate to schedule one dual-antenna user and one single-antenna user, and the matching pair is known as a hybrid matching pair composed of one dual-antenna user and one single-antenna user. Finally, if any of the foregoing six matching pairs lacks two dual-antenna users for scheduling, lacks the foregoing hybrid matching pair (composed of one dual-antenna user and two single-antenna users) for scheduling, and lacks the foregoing hybrid matching pair (composed of one dual-antenna user and one single-antenna user) for scheduling, it indicates that one of the two users in the matching pair corresponds to zero data. In this case, no matching user pair exists, and the data of a single user is sent, without the need of SDMA. If any of the foregoing six matching pairs lacks users for scheduling, the transmission rate of the matching pair is zero, and the matching pair is not considered for deployment.

Through the foregoing method, one of the following items is obtained: two dual-antenna users that are available for scheduling and correspond to each of the six matching pairs; or, one dual-antenna user and two single-antenna users; or, one dual-antenna user; or, one single-antenna user, or one dual-antenna user.

Step S304: The users included in the matching pair corresponding to the maximum sum rate are selected as the currently scheduled transmitting users. A mentioned above, the users may be: two dual-antenna users; or, one dual-antenna user and two single-antenna users; or, one dual-antenna user and one single-antenna user; or, one dual-antenna user.

An apparatus for scheduling SDMA in this embodiment includes:

a module adapted to select sort the users into multiple classes according to the index of the most matching precoding matrix of the user and the index of the minimally interfering cluster, where the most matching precoding matrixes of multiple users of a class correspond to the same cluster, and the minimally interfering clusters fed back by multiple users of the class are the same;

a module adapted to select specific users in each class;

a module adapted to select: match the selected specific users; generating one or more matching pairs, where each matching pair includes two users; and calculate the sum of the data transmission rates fed back by the two users in the matching pair; and

a module adapted to select: compare the sum of the data transmission rates between all the matching pairs; select a specific matching pair; and use the two users included in the specific matching pair as currently scheduled transmitting users.

This apparatus may be integrated on the base station in the network so that the base station performs scheduling of the SDMA in a process illustrated in FIG. 3.

### Embodiment 5

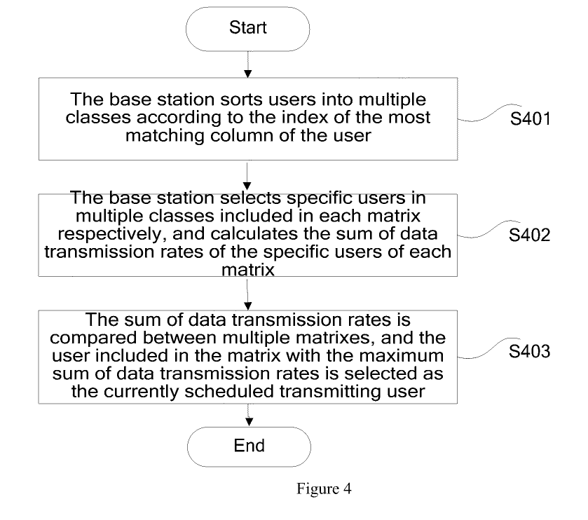

In this embodiment, a method for scheduling SDMA codebooks is provided. The method is primarily applicable to but not limited to single-antenna users. As shown in FIG. 4, the method includes the following steps:

Step S401: The base station sorts the users into multiple classes according to the index of the most matching column of each user, where the indexes of the most matching columns of multiple users of a class correspond to the same column, and the column is one of the columns (j=1 . . . n) included in multiple matrixes (marked as set 1, set 2 . . . ) that constitute part 1 of an SDMA codebook.

Step S402: Specific users in multiple classes included in each matrix are selected respectively, and the sum of data transmission rates of the specific users of each matrix is calculated, where the users are the users with the maximum transmission rates marked as Cj.

Step S403: The sum of data transmission rates is compared between multiple matrixes, and the user included in the matrix with the maximum sum of data transmission rates is selected as the currently scheduled transmitting user.

Optionally, in step S402, the selected users are the users who fail to obtain services in a long time. Accordingly, the matrix selected in step S403 is a matrix of the users, at least one of whom fails to obtain services in a long time.

An apparatus for scheduling SDMA in this embodiment includes:

a module adapted to sort users into multiple classes according to the index of the most matching column of each user, where the indexes of the most matching columns of multiple users of a class correspond to the same column, and the column is one of the columns included in multiple matrixes that constitute part 1 of an SDMA codebook;

a module adapted to select specific users in multiple classes included in each matrix respectively, and calculate the sum of data transmission rates of the specific users of each matrix; and

a module adapted to compare the sum of data transmission rates between multiple matrixes, and select the users included in a specific matrix as currently scheduled transmitting users.

This apparatus may be integrated on the base station in the network so that the base station performs scheduling of the SDMA in a process illustrated in FIG. 4.

The process described in the foregoing embodiment is only an exemplary process intended for better understanding, and the present invention is not limited to such a process. For example, in the case of Time Division Duplex (TDD), it is possible that the base station knows the index (index 1) of the most matching precoding matrix and the index (index 2) of the minimally interfering cluster without feedback from the user.

Therefore, the technical solution under the present invention suppresses the interference between SDMA users sufficiently. As regards the emulation result, the Multi Input Multi Output (MIMO) channel uses a Spatial Channel Model (SCM) of the Third Generation partnership Project (3GPP) for emulation, supposing that the channel incurs flat fading and the carrier is 2 GHz. The system schedules the SDMA codebook at an interval of 5 ms. The comparison curve is the SDMA random scheduling scheme in the prior art.

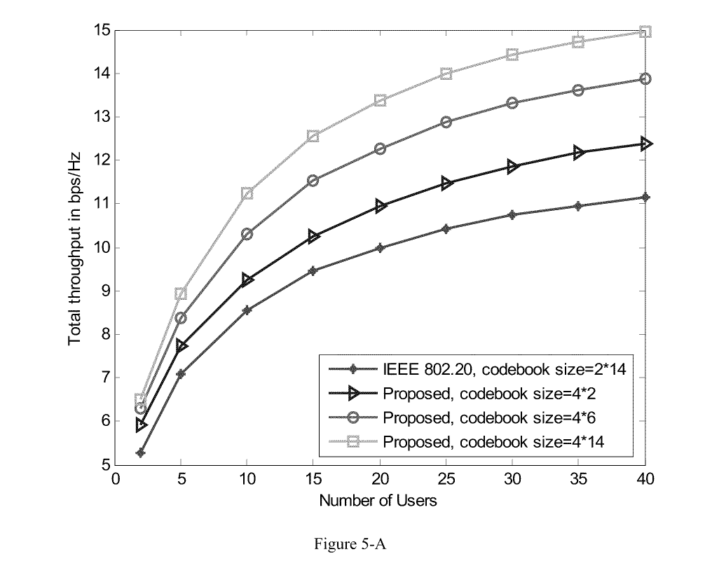

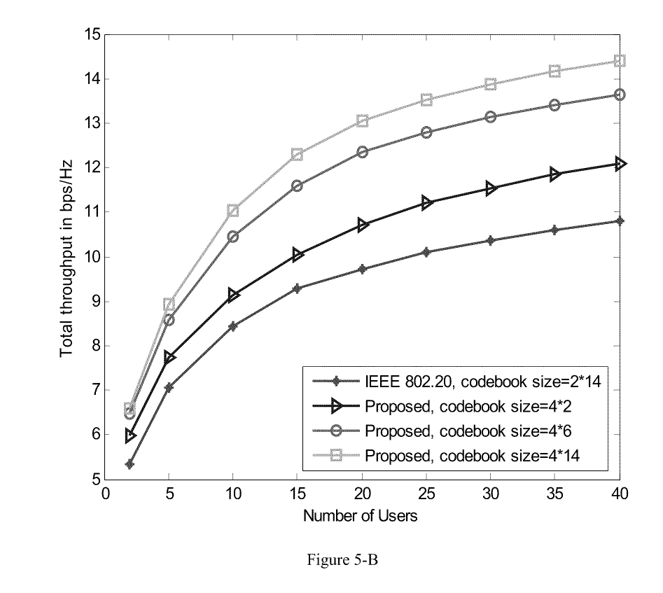

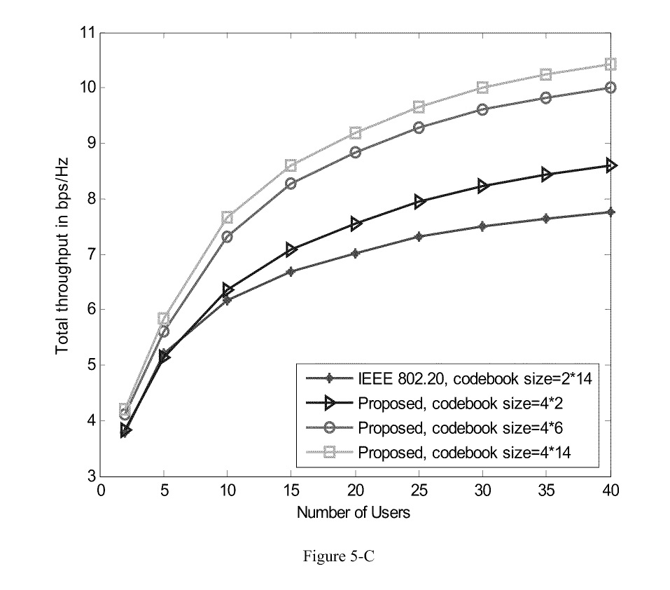

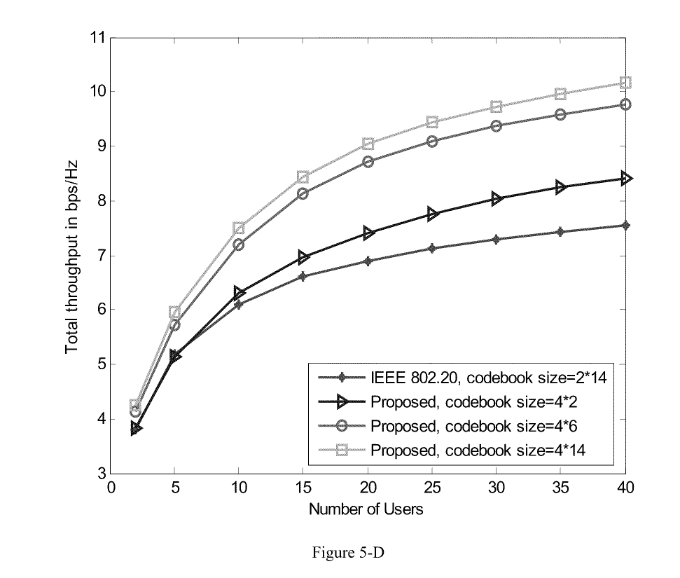

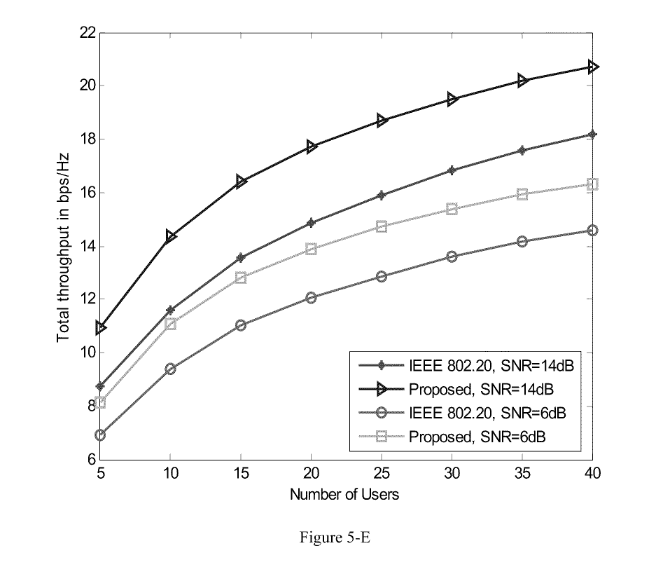

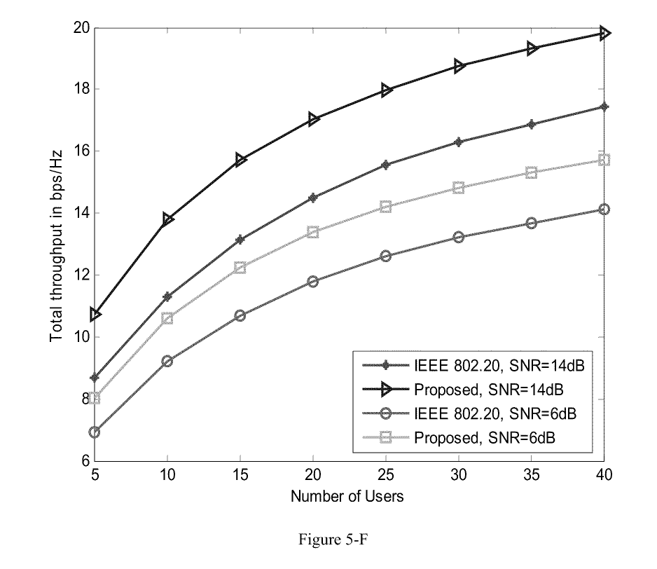

As shown in FIG. 5-A to FIG. 5-F, the emulation result reveals that the technical solution under the present invention is evidently better than the comparison curve with respect to the average throughput performance of the system.

Although the invention has been described through some exemplary embodiments, the invention is not limited to such embodiments. It is apparent that those skilled in the art can make various modifications and variations to the present invention without departing from the spirit and scope of the present invention. The invention is intended to cover the modifications and variations provided that they fall in the scope of protection defined by the claims or their equivalents.

1. A method for scheduling a Space Division Multiple Access, SDMA, codebook, the method comprising:
selecting, by a user, a most matching precoding matrix and a minimally interfering cluster in the SDMA codebook according to Channel State Information, CSI, of the user;
calculating a data transmission rate supportable when the user undergoes interference caused by the minimally interfering cluster; and
feeding back an index of the most matching precoding matrix, an index of the minimally interfering cluster, and the data transmission rate to a base station.

2. The method according to claim 1, further comprising:
selecting, by some users, a most matching precoding matrix and a minimally interfering cluster in the SDMA codebook according to their own Channel State Information, CSI;
selecting, by the rest of the users, a most matching column in the SDMA codebook according their own CSI;
calculating a data transmission rate supportable when some users undergo interference caused by the minimally interfering cluster, and calculating a data transmission rate supportable by the users that select the most matching column;
feeding back, by some users, an index of the most matching precoding matrix, an index of the minimally interfering cluster, and the data transmission rate to a base station; and
feeding back, by the users that select the most matching column, an index of the most matching column and the supportable data transmission rate to the base station.

3. The method according to claim 1, further comprising:
sorting, by the base station, users into multiple classes according to a cluster corresponding to the received index of the most matching precoding matrix and according to the index of the minimally interfering cluster;
selecting specific users in each class;
matching the selected specific users;
generating one or more matching pairs, wherein each matching pair comprises two users;
calculating the sum of data transmission rates fed back by the two users in the matching pair; and
comparing the sum of the data transmission rates between all the matching pairs, selecting a specific matching pair, and using the two users in the specific matching pair as currently scheduled transmitting users.

4. The method according to claim 3, wherein:
multiple users are sorted into the same class if: most matching precoding matrixes received by the base station and fed back by the multiple users correspond to the same cluster, and minimally interfering clusters fed back by the multiple users are the same.

5. The method according to claim 3, wherein selecting of the specific users in each class comprises:
selecting the class of the user that is fed back in each class and has a maximum data transmission rate; or
selecting the class of the user who fails to obtain services in a long time among all classes.

6. The method according to claim 3, wherein:
among the two users in the matching pair, the cluster corresponding to the most matching precoding matrix fed back by one user is the same as the minimally interfering cluster fed back by the other user.

7. The method according to claim 3, wherein:
the class is represented by (m, n), where m is a serial number of the cluster in the SDMA codebook corresponding to the index of the most matching precoding matrix, n is a value of the index of the minimally interfering cluster, and m and n are natural numbers not greater than 4.

8. The method according to claim 3, wherein:
if the class of the users sorted by the base station according to the cluster corresponding to the received index of the most matching precoding matrix and according to the index of the minimally interfering cluster lacks a corresponding feedback user, the class is null.

9. The method according to claim 3, wherein:
the selected specific users are matched; and
if one of the two users in the generated matching pair corresponds to zero data, data of a single user is sent without requiring SDMA.

10. An apparatus for scheduling Space Division Multiple Access, SDMA, comprising:
a precoding matrix selecting unit, adapted to select a most matching precoding matrix and a minimally interfering cluster in an SDMA codebook according to Channel State Information, CSI, of a user;
a calculating unit, adapted to calculate a data transmission rate supportable when the user undergoes interference caused by the minimally interfering cluster; and
a feedback unit, adapted to feed back an index of the most matching precoding matrix, an index of the minimally interfering cluster, and the data transmission rate to a base station.

11. A system for scheduling Space Division Multiple Access, SDMA, comprising a base station and a terminal, wherein:
the terminal comprises:
a precoding matrix selecting unit, adapted to select a most matching precoding matrix and a minimally interfering cluster in an SDMA codebook according to Channel State Information, CSI, of a user;
a calculating unit, adapted to calculate a data transmission rate supportable when the user undergoes interference caused by the minimally interfering cluster; and
a feedback unit, adapted to feed back an index of the most matching precoding matrix, an index of the minimally interfering cluster, and the data transmission rate to a base station;
the base station comprises:
a user classifying unit, adapted to: sort users into multiple classes according to a cluster corresponding to the index of the most matching precoding matrix and according to the index of the minimally interfering cluster, wherein the index is received by a base station;
a specific user selecting unit, adapted to select specific users in each class respectively;
a matching and calculating unit, adapted to: match the selected specific users; generate one or more matching pairs, wherein each matching pair comprises two users; and calculate the sum of data transmission rates fed back by the two users in the matching pair; and
a scheduled user selecting unit, adapted to: compare the sum of the data transmission rates between all the matching pairs, select a specific matching pair, and use the two users in the specific matching pair as currently scheduled transmitting users.

12. The system according to claim 11, wherein:
multiple users are sorted into the same class if: most matching precoding matrixes received by the base station and fed back by the multiple users correspond to the same cluster, and minimally interfering clusters fed back by the multiple users are the same.

13. The system according to claim 11, wherein the scheduled user selecting unit selecting of the specific users in each class comprises:
selecting the class of the user that is fed back in each class and has a maximum data transmission rate; or
selecting the class of the user who fails to obtain services in a long time among all classes.
